(19) United States
(12) Patent Application Publication
(10) Pub. No.: US 2021/0375508 A1
(43) Pub. Date: Dec. 2, 2021

(54) ELECTRICAL SPOOL DEVICE HAVING INCREASED ELECTRICAL STABILITY

(71) Applicant: Rolls-Royce Deutschland Ltd & Co KG, Blankenfelde-Mahlow (DE)

(72) Inventors: Mykhaylo Filipenko, Erlangen (DE); Michael Frank, Uttenreuth (DE); Jörn Grundmann, Großenseebach (DE); Peter van Hasselt, Erlangen (DE)

(21) Appl. No.: 17/282,032

(22) PCT Filed: Sep. 24, 2019
(86) PCT No.: PCT/EP2019/075647

§ 371 Date: Apr. 1, 2021

(30) Foreign Application Priority Data
Oct. 2, 2018 (DE) 102018216904.7

(51) Int. Cl. H01B 12/06; H01B 12/14; H01F 6/02; H01F 6/06

(52) U.S. Cl. CPC H01B 12/06; H01F 6/06; H01F 6/02; H01B 12/14

(57) ABSTRACT

An electrical spool device having at least one coil winding composed of a superconducting strip conductor is specified. The strip conductor includes: a strip-type substrate having two main surfaces; at least one planar superconducting layer applied on a first main surface of the substrate; and at least one outer electrical coupling layer applied on at least one of the main surfaces of the conductor composite thus formed. In this case, the coupling layer brings about an electrical coupling of adjacent turns of the coil winding, wherein the electrical coupling is dimensioned such that the time constant for electrical charging and/or discharging of the coil winding is in the range of 0.02 seconds and 2 hours.

The present patent document is a § 371 nationalization of PCT Application Serial No. PCT/EP2019/075647, filed Sep. 24, 2019, designating the United States, which is hereby incorporated by reference, and this patent document also claims the benefit of German Patent Application No. 10 2018 216 904.7, filed Oct. 2, 2018, which is also hereby incorporated by reference.

### TECHNICAL FIELD

The present disclosure relates to an electrical spool device with at least one spool winding of a superconducting strip conductor, wherein the strip conductor includes a strip-shaped substrate with two main surfaces and at least one two-dimensional superconducting layer applied to a first main surface of the substrate.

### BACKGROUND

Numerous electrical spool devices with spool windings of superconducting strip conductors are known from the prior art. For example, such spool windings are used as excitation spools in rotating machines, as storage spools in superconducting magnetic energy storage devices (SMES), as transformer spools, or also as magnetic spools in magnetic resonance devices. Strip conductors may be used which have a strip-shaped, mostly metallic substrate as the carrier substrate and a two-dimensional superconducting layer, (e.g., of a high-temperature superconducting material), deposited thereon. When electrical spools are wound from such strip conductors, the individual turns of the winding may be electrically insulated from one another so that the current flows spirally over the individual turns and not across them in the form of a short circuit directly from turn to turn.

In order to electrically insulate the adjacent turns of such a spool winding from one another, the strip conductor used during winding may be coated or enclosed with an electrically insulating material before the winding is produced. Such an insulating layer may also have the effect that a defined distance is maintained between the electrically conducting components of the turns. Such a well-defined distance between the conductor turns only be achieved by other methods with relative difficulty. Superconducting spools may either be provided with an impregnating resin between the turns during winding or encapsulated with an insulating potting compound after winding. In the first case, one speaks of wet winding, and in the second case, one speaks of dry winding with subsequent spool potting. In both cases, however, it is difficult to use the impregnating resin or the potting compound to create a well-defined distance between the conducting areas of the individual turns. For reliable and well-defined electrical insulation between the individual turns, it is therefore advantageous to provide an insulating layer of a defined thickness between the electrically conducting components of the turns.

In the case of conventional insulated strip conductors, the substrate provided with the superconducting layer may be provided with an electrically insulating polymer layer either by extrusion or by having the insulating polymer layer wrapped around it. For this purpose, the conductor structure may be wrapped with a Kapton tape. Alternatively, an electrically insulating plastic tape may be loosely inserted between the individual conductive turns.

A disadvantage of the known spool windings is that the current density of such a spool is limited, even with very high current carrying capacities of the superconducting layer, by the possibly quite high layer thicknesses of the substrate, the insulating layer, and the optionally present metallic cover layers. Because of all these contributions, the total thickness of the strip conductor (e.g., including insulation) is much greater than the thickness of the superconducting layer alone. In order to provide a spool device with a high current density, (e.g., for an electric machine with a high-power density), it would be advantageous to reduce the total thickness of the strip conductor compared to the prior art.

An electrical current may be fed very quickly into the described, known spool windings of strip conductors with insulation of the turns. The speed of electrical charging and discharging depends, among other things, on the thickness and quality of the insulation of the turns. In certain examples, thicknesses of the insulating layer of a few 10 micrometers (pm) and winding geometries for the applications mentioned, the electrical time constant for the electrical charging and/or discharging of the spool winding may be in the range of a few milliseconds (ms) or even less.

However, the disadvantage of such rapidly charging and discharging spool windings is that the spool windings may also quench very easily and may be damaged by such a quench if the critical current of the spool winding is reached or exceeded in the event of a fault. A superconducting spool winding is referred to in the art as quenching when the electrical losses that occur as a result of the critical current density in the superconductor material suddenly being exceeded have the effect that heat is suddenly introduced into the superconductor. This sudden introduction of heat leads to a loss of the superconducting properties and may lead to strong local heating and, as a result, to thermal damage to the superconductor material. If there is bath cooling, (e.g., if the superconducting spool winding is bathed in a liquid cryogenic coolant), there may also be an undesirable sudden evaporation of parts of the liquid coolant. It may therefore be desirable to reduce the risk of such a quench when operating a superconducting spool device.

### SUMMARY AND DESCRIPTION

The object of the disclosure is therefore to specify an electrical spool device which overcomes the disadvantages mentioned. In particular, a spool device with which the risk of a quench is reduced compared to the prior art is to be made available.

The scope of the present disclosure is defined solely by the appended claims and is not affected to any degree by the statements within this summary. The present embodiments may obviate one or more of the drawbacks or limitations in the related art.

This object is achieved by the electrical spool device described herein. The electrical spool device has at least one spool winding of a superconducting strip conductor. In this case, the strip conductor includes a strip-shaped substrate with two main surfaces and at least one two-dimensional superconducting layer applied to a first main surface of the substrate. Furthermore, the strip conductor includes at least one external electrical coupling layer, which is applied to at least one of the main surfaces of the conductor assembly formed in this way. This coupling layer brings about an electrical coupling of adjacent turns of the spool winding. This electrical coupling is dimensioned in such a way that the time constant for electrical charging and/or discharging of the spool winding is in the range of 0.02 seconds and 2 hours.

In other words, the coupling layer described creates an additional electrical path in that it electrically connects the adjacent turns of the spool winding to one another in the manner of a cross connection. This electrical cross connection then exists as a parallel electrical current path in addition to the main electrical current path, which spirally follows the individual turns of the strip conductor. In a normal operating state of the electrical spool device, in which the strip conductor is cooled to a sufficiently low cryogenic operating temperature below the transition temperature of the superconductor and in which the current density in the superconductor is below the respective critical current density, the current in the spool winding is transported essentially loss-free via the spiral main electrical path. The cross connection additionally created by the described electrical coupling layer has an effect however both during normal charging and discharging of the spool winding and during its reaction in the event of a fault.

The mentioned time constant for charging and/or discharging the spool may refer to the time constant τ with which the magnetic field generated by the spool builds up or breaks down. For a spool with insulation of the turns, in which the resistance for the parallel current path may be viewed almost as infinitely high, the time required for charging and/or discharging is negligibly small. It is also not dominated by a time constant of the spool in the classic sense, but rather by the properties of the connected power source and thermal effects. In the case of a spool in which the turns are not completely isolated from one another and a finite resistance R_{q} is present in the parallel current path that connects the turns directly to one another, the time for charging or discharging is actually determined by a time constant τ. This time constant is given by the ratio τ=L/R, where L denotes the inductance of the spool and R denotes the total effective resistance of the spool winding. This total resistance is dominated by the resistance R_{q} of the cross connection, because the spiral main electrical path of the spool is of course superconducting. When a current source is connected, (or when a voltage applied to the spool changes, for example), the magnetic field formed by the spool changes with the described time constant. Even if the current flowing overall through the spool changes significantly faster, the change in the magnetic field in a spool winding with a parallel current path R_{q} is comparatively slow. This is because the current flowing in the transverse path may change very quickly, but the change in the current flow only commutates very slowly from the transverse path into the superconducting spiral main path of the spool winding.

By dimensioning the transverse conductivity between adjacent turns brought about by the electrical coupling layer, the desired time constant may be set for a given spool inductance L. In certain examples, with a higher electrical coupling of the turns, the effective R is smaller and thus the time constant for charging and discharging is increased. A comparatively long charging and discharging time, even above the millisecond range, may however be accepted in many applications, because the electrical coupling layer at the same time protects the superconducting spool device from premature quenching. Depending on the required boundary conditions for the current to be tolerated, the dielectric strength and the required charging speed, the effective electrical time constant may be set in a targeted manner by suitable choice of the resistivity of the material and the layer thickness of the coupling layer.

An advantage of the spool device is that the electrical cross connection between adjacent turns provides effective protection from damage caused by quenching. The mechanism for this protective effect works as follows. As long as the current flowing in the spool winding is below the critical current of the spool winding, the current flows almost loss-free via the spiral main electrical path, specifically via the superconducting layer of the strip conductor arranged spirally within the winding. If the critical current of the superconducting spool winding is exceeded, for example due to a fault, then with increasing current an ever increasing proportion of the total current may flow directly from turn to turn via the additional cross connections created by the coupling layer. The transfer of an ever larger part of the increasing current into this parallel current path takes place with a comparatively low local heating, because the distance from turn to turn is short and there is a high material cross section available in the coupling layer (e.g., the entire layer surface) for the current transport. And even if heat is released in the coupling layer due to the ohmic losses, this happens in a larger region and not at a very localized area of the superconducting layer. The cross connection created by the electrical coupling layer thus significantly reduces the risk of loss of the superconducting properties and damage to the superconductor due to sudden local heating when the critical current of the spool winding is exceeded.

The superconducting layer may be in particular a high-temperature superconducting layer. High-temperature superconductors (HTS) are superconducting materials with a transition temperature above 25 K and in the case of some material classes above 77 K, where the operating temperature may be reached by cooling with other cryogens than liquid helium. HTS materials are particularly attractive because, depending on the choice of operating temperature, these materials may have high upper critical magnetic fields and high critical current densities.

The high-temperature superconductor may include magnesium diboride or a ceramic oxide superconductor, for example, a compound of the type REBa₂Cu₃Oₓ (REBCO for short), where RE is a rare earth element or a mixture of such elements.

According to a first advantageous embodiment, the time constant for electrical charging and/or discharging of the spool winding may be in the range of 0.1 seconds and 10 minutes. Such a time constant chosen to be rather low within the range of values may be achieved in particular by choosing the resistance of the cross connection created by the coupling layer to be comparatively high for a given spool inductance L. For this purpose, the corresponding specific conductivity of the coupling layer may be chosen to be comparatively low and/or the layer thickness of the coupling layer may be chosen to be comparatively high. Overall, the choice of such a comparatively short time constant is particularly advantageous whenever comparatively short charging and discharging times are required for the application of the spool winding. Due to the moderate electrical coupling of the adjacent turns then provided by the coupling layer, significant protection of the winding from local overheating during quenching may already be achieved for the dimensioning described here—although the electrical coupling is still comparatively low here.

According to an alternative, second advantageous embodiment, the time constant for electrical charging and/or discharging of the spool winding may be in the range of 10 minutes and 2 hours. Such a comparatively high time constant may be achieved by choosing the resistance of the cross connection created by the coupling layer to be comparatively low for a given spool inductance L. For this purpose, the corresponding specific conductivity of the coupling layer may be chosen to be comparatively high and/or the layer thickness of the coupling layer may be chosen to be comparatively low. Overall, the choice of such a comparatively high time constant is particularly advantageous whenever comparatively long charging and discharging times may be tolerated for the application of the spool winding. Due to the comparatively strong electrical coupling of the adjacent turns then provided by the coupling layer, even much greater protection of the winding from local overheating during quenching may be achieved for the dimensioning described here.

Advantageously, the electrical coupling layer may be arranged at least on the side of the strip conductor which carries the superconducting layer. In other words, the superconducting layer may thus be covered by the coupling layer (e.g., directly or indirectly, in the latter case therefore via an intermediate layer).

In this embodiment, it may be particularly advantageous for there to be arranged between the superconducting layer and the coupling layer an additional two-dimensional conducting cover layer. This cover layer may be connected directly to the superconducting layer. An advantage of such a conducting cover layer is that the cover layer forms a conducting parallel resistance with respect to the superconducting layer, which in particular is electrically connected directly to it. Such a conducting cover layer may be formed from a metallic material (e.g., a metal or a metal alloy). The material of the cover layer may include copper or silver or even consist essentially of one of these materials. In this embodiment, the coupling layer applied to the cover layer then brings about sufficient electrical coupling between the upper cover layer of a given conductor turn and, e.g., the likewise electrically conductive lower layer of the next adjacent conductor turn (e.g., the next substrate layer). Alternatively, or additionally, such a cover layer may also be applied on the side of the substrate that is facing away from the superconductor. It may also enclose the entire layer structure underneath.

In certain examples, independently of the optional presence of a cover layer, the coupling layer may advantageously be arranged on the side of the strip conductor that carries the superconducting layer. Alternatively, or additionally, the coupling layer may also be arranged on the side of the strip conductor that is facing away from the superconducting layer. In particular, it is possible for the coupling layer to be arranged on both main surfaces of the strip conductor. In this embodiment, the coupling layer may enclose the conductor assembly in particular over its entire cross section, so that the sides of the conductor assembly are also covered by this coupling layer.

In certain examples, advantageously, the substrate of the strip conductor may be formed from a normally conducting material. In this embodiment, the substrate therefore also contributes to the electrical cross connection between the superconducting layers of the individual adjacent turns. The conductive design of the substrate, however, is not absolutely necessary. In principle, it is sufficient if the superconducting layer of a given turn is connected in a conducting manner to the electrical coupling layer of the same turn and if this electrical coupling layer is connected to any electrically conductive layer of the adjacent turn, which then in turn is electrically conductively connected to the superconducting layer of this adjacent turn. All that is necessary is for an electrical connection between the superconducting layers of adjacent turns to be established in a suitable manner by the coupling layer. If the substrate itself is not electrically conductive, such an electrical connection of the superconducting layer may alternatively also be achieved by an enclosing, electrically conductive stabilizing layer.

In the case of the strip conductor, the coupling layer may be applied as a direct coating on the underlying layer. Such a direct coating may be understood as meaning that the coupling layer is only formed in situ as a solid layer on the conductor assembly. In particular, it may therefore not take the form of a prefabricated solid layer which is only subsequently connected to the conductor assembly. Different coating processes are conceivable, (e.g., from the gas phase), from an aerosol or else in principle also from a solution or melt. If necessary, the coupling layer may also be created by a chemical reaction of the material of the relevant main surface with a surrounding medium. A particular advantage of the direct coating of the strip conductor is that as a result the coupling layer hugs the other layers of the conductor assembly very closely, thus avoiding larger gaps between the conductor assembly and the coupling layer. According to the state of the art, such gaps easily occur in the insulating layers for example when solid insulating tapes are subsequently connected to the conductor assembly and, in particular at the edges of the conductor assembly, a perfect adaptation of the geometry of the insulating layer is not possible. Avoiding such gaps is advantageous for a good thermal connection of the winding package and, in particular, its superconducting layer to an external heat sink or a cooling medium.

In the combination of the embodiment with a direct coating with the aforementioned variant with application of the coupling layer on both sides or even enclosing it, it may happen that the mentioned “underlying layer” changes. For example, on the underside of the strip conductor, the coupling layer may be applied as a direct coating on the substrate, while on the upper side of the strip conductor, it is applied as a direct coating, either on the superconducting layer or on the cover layer lying above it. In the case of the enclosing variant, the coupling layer also additionally rests on all side edges of the entire stack of layers. In this case, the “underlying layer” mentioned is to be understood as the “respectively underlying layer”.

The coupling layer may advantageously have a layer thickness in the range of 1 μm and 100 μm, in the range of 2 μm and 20 μm, or in the range of 2 μm and 10 μm. A layer thickness in the ranges mentioned is particularly suitable in order to provide a sufficiently accurately adjustable electrical coupling from turn to turn with homogeneous deposition. In particular, the layer thicknesses are small enough to obtain a thin strip conductor overall and thus allow a comparatively high current density in the spool winding. In particular, in combination with the variant of direct coating, the comparatively thinner layer thicknesses are advantageous in order to allow very high current densities in the winding.

In certain examples, advantageously, the material of the coupling layer may include a semiconductor material, an inorganic metal compound, and/or an organometallic compound. In particular, the coupling layer material may be a compound (or possibly also a mixture of a number of compounds) of a metal which forms the substrate (or is at least contained in it) and/or which forms the normally conducting cover layer (or is at least contained in it). In particular, the coupling layer material may therefore be an inorganic and/or organometallic copper compound, iron compound, or nickel compound. In the case of this type of embodiment, the coupling layer may be formed by an in-situ reaction on the surface of the substrate, or the cover layer of the material contained there. For example, a copper oxide may be formed by oxidation of the copper that forms the substrate or the cover layer. In a similar way, other oxides or nitrides may be formed from other metals. It is also possible, for example, to form inorganic salts (e.g., copper sulfate) by reaction of the metal with a corresponding inorganic reactant or organometallic compounds by reaction with a corresponding organic reactant in situ on the respective metal surface. According to a first embodiment variant, it is possible to provide the substrate that has already been coated with the superconducting layer with the additional coupling layer. It is important to maintain reaction conditions (in particular, a low reaction temperature) in which the superconducting layer is not damaged. Alternatively, it is also possible in principle to apply the coupling layer to the rear side of the substrate before coating with the superconductor, so that the reaction conditions may be chosen regardless of the superconducting layer. As an alternative, or in addition, it is also possible to apply the coupling layer on one side to an inherently stable cover layer before this cover layer is then connected on the other side to the superconductor-coated substrate. In this case too, the reaction conditions may be chosen regardless of the superconducting layer, and higher reaction temperatures, (e.g., 200° C. and more), may also be used. The last-mentioned variants, in which the reaction conditions may be chosen regardless of a sensitive superconductor, are particularly suitable for the deposition of ceramic layers such as oxides and nitrides.

Doped diamond, silicon, germanium, gallium, arsenic, and/or compounds with these elements are particularly suitable as semiconducting materials for the coupling layer. The materials mentioned may optionally also be doped with other substances in order to achieve a desired resistivity. When using metals or graphene as a material component of the coupling layer, it may be expedient to increase the resistivity of the overall layer by adding a further electrically less conductive component in the layer. The individual components do not have to be evenly mixed, but it may also be advantageous under certain circumstances to alternate a number of components with one another, for example in a sandwich-like layer change, in order to set a desired electrical coupling.

In certain examples, regardless of the exact choice of material, it is advantageous if the coupling layer is formed from a material with semiconducting properties. In particular, such a coupling layer is characterized by a negative temperature coefficient of the resistivity. In addition, the electrical resistivity may be in a range of 10⁻⁶ Ohm·m and 10⁵ Ohm·m.

Such a semiconducting coupling layer may be particularly advantageous in order to set a moderate electrical coupling of the adjacent turns. Such a moderate coupling may be particularly advantageous in order to achieve an adequate effect of protection from damage during quenching with at the same time not excessively increased charging and discharging times of the spool winding.

Alternatively, or additionally, the electrical coupling layer may include an electrically conductive metallic material. In particular, it may be a comparatively poorly conductive metal, for example with an electrical resistivity above 10⁻⁷ Ohm·m. A coupling layer of such a metallic material may for example have a comparatively high layer thickness (e.g., in the range above 20 μm) in order to achieve a moderate electrical coupling with the desired dimensioning of the time constant despite the high specific conductivity.

Alternatively, or additionally, the electrical coupling layer may include a material with a specific electrical resistivity above 10⁵ Ohm·m. Such an insulating material may be advantageous in particular whenever a comparatively weak electrical coupling is desired. In particular, comparatively low time constants may then be set. In this embodiment, it may be advantageous if the coupling layer has a multiplicity of flaws distributed over the layer. Such flaws may be gaps in the insulating layer, in which a direct electrical connection of the conductive layers to be coupled by the coupling layer is made possible. For example, an electrical coupling layer may be implemented between two metallic layers as a thin resin layer, which is itself electrically insulating but is so thin that it only fills the gaps between the spikes of the natural surface roughness of the metallic layers. The insulating layer is interrupted at the area of the spikes, so that there are a multiplicity of flaws distributed over the layer. Alternatively, it is also conceivable that for example the holes in an electrically conductive perforated plate are filled by a thin insulating layer in order to set overall a desired value for the transverse resistance R_{q}.

The electrical coupling layer may therefore also include an organic material, which may be electrically insulating. Such a layer may be implemented, for example, by an organic polymer, (e.g., a lacquer and/or a resin).

The electrical spool device may advantageously be a spool device in an electric machine (e.g., in the rotor and/or in the stator), in a transformer, and/or in a superconducting energy store (e.g., in an SMES=superconducting magnetic energy store).

### BRIEF DESCRIPTION OF THE DRAWINGS

The disclosure will be described below using a number of exemplary embodiments with reference to the appended drawings, in which:

FIG. 1 depicts a schematic view of a detail through a spool device according to the prior art.

FIG. 2 depicts a schematic view of a detail of a spool device according to an exemplary embodiment.

FIG. 3 and FIG. 4 depict schematic cross-sectional representations of examples of strip conductors in such a spool device.

FIG. 5 depicts a schematic representation of an example of the dependence of the magnetic flux of such a spool device in dependence on the current.

In the figures, elements that are the same or have the same function are provided with the same reference signs.

### DETAILED DESCRIPTION

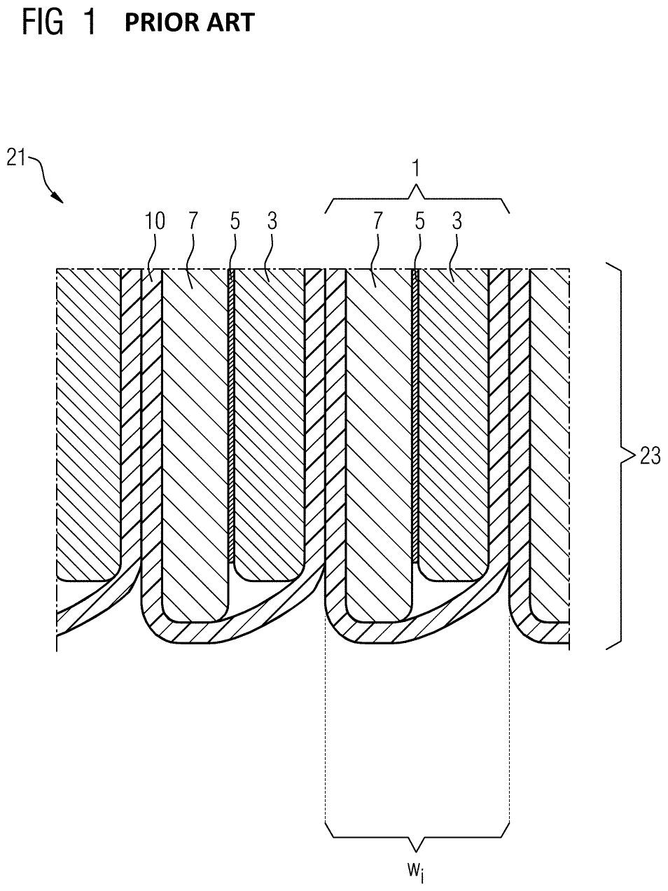

FIG. 1 depicts a detail from a spool device 21 with a spool winding 23 according to the prior art. A partial region of a cross section of the spool winding 23 in an edge region of the winding is shown. The spool winding 23 here includes a multiplicity of turns wᵢ, of which, by way of example, only the edge regions of two turns are shown in full and the edge areas of the two adjoining turns are partially shown. The individual turns wᵢ are formed by winding a strip conductor 1, the structure of which will now be explained in more detail. The strip conductor 1 has a metallic substrate 3, on one main surface of which a two-dimensional superconducting layer 5 is formed. This superconducting layer 5 is covered by a normally conducting cover layer 7, which may likewise be formed from a metallic material, (e.g., copper and/or silver). Each of the layers shown may include a number of partial layers and additional intermediate layers may also be arranged between the individual layers, in particular, one or more buffer layers between the substrate 3 and the superconducting layer 5. In this strip conductor 1 according to the prior art, the conductor assembly thus formed is wrapped by an electrically insulating plastic tape 10. This insulator is used to electrically isolate the adjacent spool turns wᵢ.

The problem with the conventional spool device 21 of FIG. 1 is on the one hand that the spool device is relatively susceptible to thermal damage to the thin superconducting layer 5 in the event of a sudden quench. A further disadvantage of the conventional spool device 21 is that the insulator 10 is comparatively thick. Due to its contribution to the total thickness of the strip conductor 1, the current density that may potentially be achieved in the entire spool winding 23 is also limited.

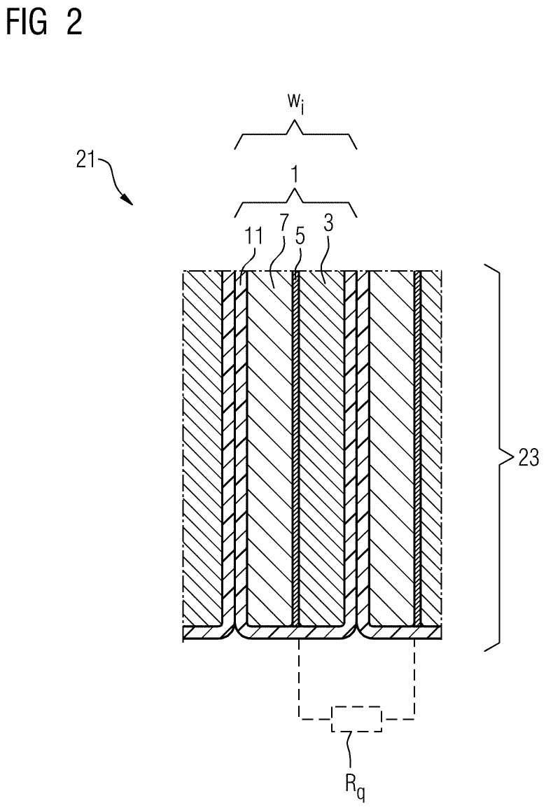

FIG. 2 depicts a schematic view of a detail through a spool device 21 according to an exemplary embodiment. The illustration is analogous to the illustration of the conventional spool device in FIG. 1. Here, too, the edge region of a spool winding 23 is shown, e.g., the underside of a flat spool. In contrast to the spool device of FIG. 1, the strip conductor 1, from which the winding is formed, is not wrapped with an insulator 10, but is provided with an enclosing electrical coupling layer 11. This coupling layer 11 may be applied as a direct coating on the conductor assembly, the aforementioned conductor assembly being formed similarly to in FIG. 1 by a metallic substrate 3, a superconducting layer 5 arranged thereon, a normally conducting cover layer 7 arranged thereon, and optionally further intermediate layers not shown here.

In the spool element 21 of FIG. 2, the entire strip conductor 1 is made significantly thinner than in the conventional spool element 21 of FIG. 1. On the one hand, the electrical coupling layer 11 is made thinner than the insulator 10 in the conventional spool winding. On the other hand, the substrate 3 and the normally conducting cover layer 7 are also chosen to be comparatively thin here. All of this favors a comparatively high current density in this spool winding 23.

A difference between the spool device of FIG. 2 and the spool device of FIG. 1 is that the electrical coupling layer 11 electrically connects the adjacent turns wᵢ of the spool winding to one another in such a way that a transverse conductivity is made possible between the superconducting layers 5 of adjacent turns. The effective resistance for this cross connection (over the length of a spool turn) is only indicated extremely schematically in FIG. 2 as R_{q}. In the example of FIG. 2, the layers 3 and 7 adjoining the superconducting layer 5 are also formed as metallic conductors. In contrast, the coupling layer 11 is formed in this example from a semiconducting material. Overall, this results in a moderately conductive cross connection between the superconducting layers 5 of adjacent turns. The layer thickness and the resistivity of the coupling layer 11 (and thus the resistance R_{q} the cross connection) are set in such a way that, in combination with the total inductance of the spool winding, there is a time constant for electrical charging and discharging in a range of 0.02 seconds and 2 hours.

As an alternative to the semiconducting coupling layer 11 present in the example of FIG. 2, this coupling layer may also be formed from an insulating material with a number of flaws (e.g., gaps). In this case, an electrical connection between the conductive substrate 3 of a given turn and the metallic cover layer 7 of the adjacent turn may be made possible in the region of the flaws, for example, by spikes in the respective metallic layers that penetrate the electrically insulating coupling layer 11.

According to a further possible alternative, the coupling layer may also be formed from a moderately electrically conductive metallic material which has a comparatively high layer thickness. Also in this embodiment, the resistance of the cross connection may be suitably set in order to set a time constant within the stated range of values in conjunction with the inductance of the spool winding.

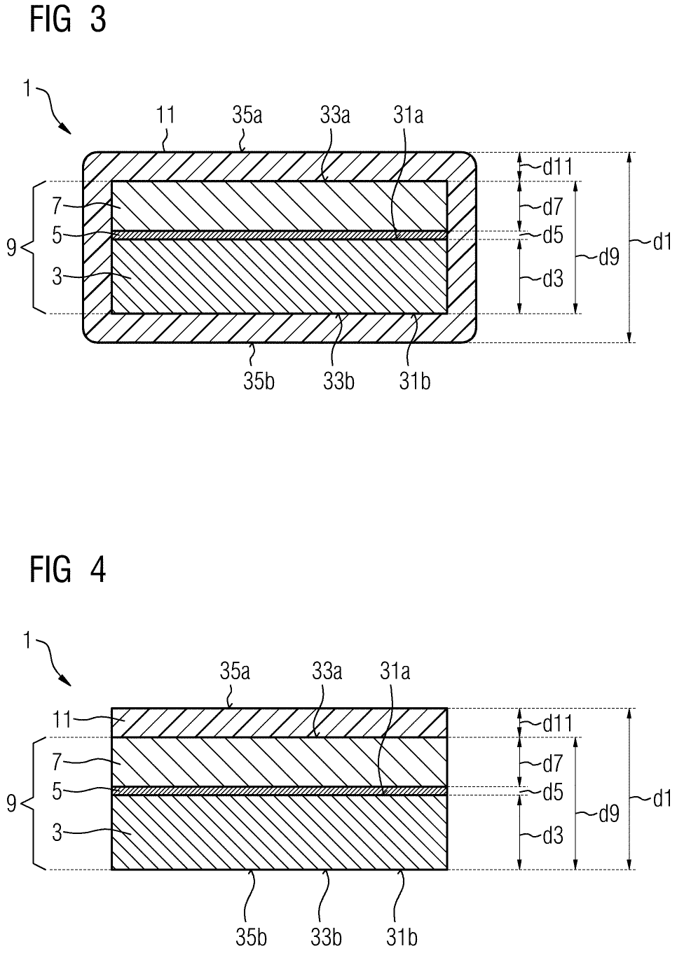

FIG. 3 depicts a schematic cross-sectional view of a strip conductor 1, which may be used in a spool device and may be constructed overall in a manner similar to the strip conductor of FIG. 2. The strip conductor 1 includes a metallic substrate 3, which has two main surfaces 31a and 31b. A two-dimensional superconducting layer 5 is deposited on the first main surface 31a over a stack of buffer layers that are not shown here. This superconducting layer 5 is in turn covered by a metallic cover layer 7. This cover layer 7 may include copper, silver, or a stack of both materials. The substrate, the superconducting layer 5, and the cover layer 7 as well as the buffer layers not shown together form a conductor assembly 9. This conductor assembly 9 is enclosed here over its entire cross section by an electrical coupling layer 11. This electrical coupling layer is electrically conducting or semiconducting or electrically insulating with a multiplicity of flaws (gaps) distributed over the layer. It provides sufficient electrical coupling from turn to turn within a spool winding constructed with this strip conductor 1. The coupling layer may be formed for example as a thin semiconductor layer. The semiconducting property may be achieved either by doping a material that is not inherently conductive (e.g., diamond) and/or also by an intrinsically semiconducting material. By doping diamonds, for example, low resistivities in the range down to below 10⁻⁶ Ohm·m may be achieved. Numerous other materials are also conceivable for this coupling layer 11.

Not wrapping the tape conductor with an insulator 10 makes it possible to choose the thickness d1 of the entire strip conductor to be very thin. The thickness d11 of the coupling layer 11, (e.g., applied by direct coating), may be advantageously chosen to be significantly thinner than that of a conventional insulator film. The thickness of the substrate d3 and/or the thickness of the cover layer d7, and thus also the thickness of the entire conductor assembly d9 enclosed by the coupling layer 11, may also be chosen to be very thin in order to achieve overall a high current density.

FIG. 4 depicts a schematic cross-sectional view of an alternatively designed strip conductor, as it may also be used in a spool device 21 as disclosed herein. The underlying conductor assembly 9 is constructed analogously or very similarly to the conductor assembly 9 of FIG. 3. The coupling layer 11 is also formed from a material with similar properties. As a difference from the example of FIG. 3, this coupling layer is not deposited as an enclosing layer, but only on one side of the conductor assembly. In the example of FIG. 4, the coupling layer is deposited on the first main surface 33a of the conductor assembly 9, which corresponds to the first main surface 31a of the substrate 3. This first main surface of the substrate is the surface to which the superconducting layer 5 is applied. It also corresponds to the first side 35a of the strip conductor 1. Such a coupling layer 11 on this first side of the strip conductor 1 also achieves a sufficient electrical coupling of the successive turns when a winding is produced from the strip conductor, because the metallic layers are connected by the semiconducting, conducting, or at least flawed coupling layer 11. Analogously to the example of FIG. 2, the individual layer thicknesses may also be made very thin here. Because the coupling layer 11 is only applied on one side here, the total thickness d1 of the strip conductor 1 may even be chosen to be even thinner.

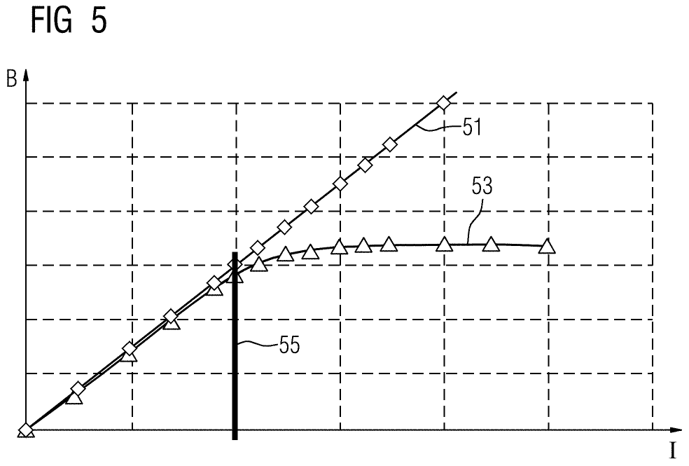

FIG. 5 depicts a schematic representation of the dependence of the magnetic flux B on the current I in a spool device according to an example. In the case of this spool device, the coupling layer is formed from a semiconducting material, as a result of which a moderate electrical coupling of adjacent turns is achieved. This allows protection from damage of the superconductor in the event of high currents. This protective function is to be explained in more detail below in connection with FIG. 5. The curve 51 shows the theoretical linear profile of the magnetic flux B in dependence on the current I, which is to be expected for a conventional, winding-insulated spool. In contrast, curve 53 shows the actually observed profile of the magnetic flux B for a spool device. For low currents I, which are well below the critical current 55, the actual curve 53 essentially follows the linear theoretical curve 51, because the conductor material here is superconducting and the voltage drop across the winding is accordingly negligible. The current flowing through the spool device thus flows through the superconducting material of the spool turns (e.g., the spiral main path). When the current in the superconducting material reaches the range of the critical current 55, however, the voltage drop across the superconducting part of the winding is no longer negligible. Therefore, in the range of the critical current 55, other paths are also relevant for the current transport, because their resistances are no longer negligible in comparison with the resistance of the superconductor material, which is then increasing rapidly according to the U-I characteristic. This is in principle both for a conventional turn-insulated spool winding and for the spool winding according to the exemplary embodiment with electrical coupling of the turns. An important difference between insulation of the turns and coupling of the turns is that, in the case of a winding with an insulator between the turns, the parallel current path leads over the normally conducting parts of the strip conductor, that is to say for example the metallic substrate and/or the metallic cover layer. In the regions of the winding in which the superconduction breaks down first, this leads to a strong local heat development in the relevant normally conducting parts of the strip conductor, in other words to the formation of so-called hot spots. This in turn leads to what is known as quenching of the spool winding, e.g., a complete breakdown of the superconducting properties due to overheating of the superconductor material and resultant exceeding of the transition temperature of the superconductor. If the current in the spool cannot be reduced quickly enough by active measures, this area may even heat up to such an extent that the strip conductor is ultimately irreparably damaged, and the spool is destroyed.

In the embodiment with an electrical coupling layer, such quenching may be avoided by the following mechanism. This is because an additional parallel current path (with resistance Rq) is formed here via the coupling layer, which acts as a cross connection from turn to turn. Although the coupling layer under certain circumstances only causes a moderately strong electrical coupling, a significant proportion of the current may flow via this path when the critical current 55 is reached due to the much shorter path and much larger cross section of these cross connections. The overall path is made up in the manner of cascade of a series connection of the individual cross connections of the turns lying one above the other. Because the distance from turn to turn is so short and the material cross section for this current path is so large, there is no particularly strong local heating that would lead to local overheating of the winding. As a result, the spool device may be operated at a total current I which may be significantly above the critical current 55. Initial experiments were able to achieve a factor of two or more. In this operating mode, the so-called “residual current” (that is approximately the current that exceeds the critical current 55) flows through the cross-current path, while a current that corresponds approximately to the critical current 55 flows furthermore through the superconducting winding and leads to the formation of an approximately constant magnetic flux B. As a result, the observed plateau in the magnetic flux occurs for currents above the critical current 55, although the total value of the current I exceeds the critical current 55. An advantage of this coupling of the turns compared to conventional windings with insulation of the turns is that the superconducting properties do not break down even with total currents above the critical current and the spool winding is protected from quenching and thermal damage to the conductor material by the “harmless parallel current path”. So it has an increased electrical stability.

In order to achieve the protective function described, a higher time constant for charging and discharging the winding is accepted compared to the prior art, resulting from the parallel connection of the various current paths as described above. By precisely coordinating the resistances and inductances of the respective current paths, however, a charging rate that is still tolerable for the respective application may be set.

Although the disclosure has been described and illustrated more specifically in detail by the exemplary embodiments, the disclosure is not restricted by the disclosed examples and other variations may be derived therefrom by a person skilled in the art without departing from the scope of protection of the disclosure. It is therefore intended that the foregoing description be regarded as illustrative rather than limiting, and that it be understood that all equivalents and/or combinations of embodiments are intended to be included in this description.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

### LIST OF REFERENCE SIGNS

1 Strip conductor
3 Substrate
5 Superconducting layer
7 Normally conducting cover layer
9 Conductor assembly
10 Insulator
11 Electrical coupling layer
21 Spool device
23 Spool winding
31a First main surface of the substrate
31b Second main surface of the substrate
33a First main surface of the conductor assembly
33b Second main surface of the conductor assembly
35a First side of the strip conductor
35b Second side of the strip conductor
51 Theoretical linear profile
53 Actual profile
55 Critical current
B Magnetic flux
d1 Total thickness of the strip conductor
d3 Layer thickness of the substrate
d5 Layer thickness of the superconducting layer
d7 Layer thickness of the cover layer
d9 Layer thickness of the conductor assembly
d11 Thickness of the protective layer
I Current
R_{q} Resistance of the cross connection
wᵢ Turns

1. An electrical spool device comprising:
at least one spool winding of a superconducting strip conductor, wherein the strip conductor comprises:
a strip-shaped substrate with two main surfaces;
a two-dimensional superconducting layer applied to a first main surface of the two main surfaces of the strip-shaped substrate; and
an external electrical coupling layer applied to at least one main surface of two the main surfaces,
wherein the electrical coupling layer provides an electrical coupling of adjacent turns of the at least one spool winding, and
wherein the electrical coupling is dimensioned such that a time constant for electrical charging and/or discharging of the at least one spool winding is in a range of 0.02 seconds and 2 hours.

2. The spool device of claim 1, wherein the time constant for the electrical charging and/or the discharging of the at least one spool winding is in a range of 0.1 seconds and 10 minutes.

3. The spool device of claim 1, wherein the time constant for the electrical charging and/or the discharging of the at least one spool winding is in a range of 10 minutes and 2 hours.

4. The spool device of claim 1, wherein the strip conductor further comprises:
a two-dimensional, normally conducting cover layer arranged between the two-dimensional superconducting layer and the electrical coupling layer of the strip conductor.

5. The spool device of claim 4, wherein the electrical coupling layer of the strip conductor is a direct coating on the two-dimensional, normally conducting cover layer.

6. The spool device of claim 1, wherein the electrical coupling layer of the strip conductor has a layer thickness in a range of 1 μm and 100 μm.

7. The spool device of claim 1, wherein the electrical coupling layer of the strip conductor comprises a semiconductor material, an inorganic metal compound, and/or an organometallic compound, or a combination thereof.

8. The spool device of claim 1, wherein the electrical coupling layer of the strip conductor comprises a material with an electrical resistivity in a range of 10⁻⁶ Ohm·m and 10⁵ Ohm·m.

9. The spool device of claim 1, wherein the electrical coupling layer of the strip conductor comprises an electrically conductive metallic material.

10. The spool device of claim 1, wherein the electrical coupling layer of the strip conductor comprises a material with an electrical resistivity of at least 10⁵ Ohm·m.

11. The spool device of claim 10, wherein the electrical coupling layer has a multiplicity of flaws distributed over the layer.

12. The spool device of claim 10, wherein the coupling layer comprises an organic material.

13. An electric machine comprising:
a stator;
a rotor; and
an electrical spool device having at least one spool winding of a superconducting strip conductor,
wherein the electrical spool device is positioned within the stator and/or the rotor of the electric machine, and
wherein the strip conductor of the electrical spool device comprises:
a strip-shaped substrate with two main surfaces;
a two-dimensional superconducting layer applied to a first main surface of the two main surfaces of the strip-shaped substrate; and
an external electrical coupling layer applied to at least one main surface of two the main surfaces,
wherein the electrical coupling layer provides an electrical coupling of adjacent turns of the at least one spool winding, and
wherein the electrical coupling is dimensioned such that a time constant for electrical charging and/or discharging of the at least one spool winding is in a range of 0.02 seconds and 2 hours.

14. A transformer or a superconducting energy store comprising:
an electrical spool device having at least one spool winding of a superconducting strip conductor,
wherein the strip conductor of the electrical spool device comprises:
a strip-shaped substrate with two main surfaces;
a two-dimensional superconducting layer applied to a first main surface of the two main surfaces of the strip-shaped substrate; and
an external electrical coupling layer applied to at least one main surface of two the main surfaces,
wherein the electrical coupling layer provides an electrical coupling of adjacent turns of the at least one spool winding, and
wherein the electrical coupling is dimensioned such that a time constant for electrical charging and/or discharging of the at least one spool winding is in a range of 0.02 seconds and 2 hours.

15. The transformer or a superconducting energy store of claim 14, wherein the superconducting energy store is superconducting magnetic energy store (SMES).

16. The spool device of claim 1, wherein the electrical coupling layer of the strip conductor has a layer thickness in a range of 2 μm and 20 μm.
